(19) United States
(12) Patent Application Publication
(10) Pub. No.: US 2026/0302769 A1
(43) Pub. Date: Oct. 1, 2026

(54) POWER SUPPLY DISTRIBUTION UNIT COMPRISING POWER SUPPLY LINES

(71) Applicant: Telefonaktiebolaget LM Ericsson (publ), Stockholm (SE)

(72) Inventors: Lackis ELEFTHERIADIS, Valbo (SE); Qiang LIU, Beijing (CN); Aixin HUANG, Beijing (CN)

(73) Assignee: Telefonaktiebolaget LM Ericsson (publ), Stockholm (SE)

(21) Appl. No.: 19/479,031

(22) PCT Filed: Sep. 19, 2023
(86) PCT No.: PCT/SE2023/050916

§ 371 Date: Oct. 27, 2025

(30) Foreign Application Priority Data
Apr. 28, 2023 (GR) 20230100355

(51) Int. Cl. H02J 1/08; G06F 1/18; H02J 9/06

(52) U.S. Cl. CPC H02J 1/086; G06F 1/189; H02J 9/061

(57) ABSTRACT

A PSDU (200) and a system (500), a corresponding method, computer program and computer program product are disclosed. The PSDU comprises separate PSLs (210) wherein each PSL supplies a different phased input power and each PSL is connected to PSUs (230) via switches (220) which connect adjacent PSLs to at least one common PSU such that an adjacent PSL can be connected or disconnected to the same PSUs. The method comprises determining whether a PSL of the separate PSLs has failed or become disconnected from an input power source; configuring, if the PSL is determined to have failed or become disconnected from the input power source, the switches to separately connect at least one of the remaining PSLs of the PSLs to at least one of the PSUs previously connected to the PSL determined to have failed or become disconnected from the input power source.

### TECHNICAL FIELD

The invention relates to methods, apparatus, and systems for providing a power supply distribution unit (PSDU) for an electronic device.

### BACKGROUND

3rd Generation Partnership Project (3GPP) technologies such as 2G, 3G, 4G, 5G and 6G services require fulfilment of various metrics such as low latency, high bandwidth and high reliability. Telecommunications equipment such as a 3GPP Radio Access Network (RAN) node depends heavily on power supplied by a corresponding enclosure system to ensure high reliability. The enclosure system itself depends on different power grid mains supplies which have a different grade of resiliency depending on the region and location around the world.

Input power mains for telecommunications equipment such as a 3GPP RAN node are directly connected via an alternating current (AC) supply to a utility power distribution system. In general, each RAN node has three incoming power lines, L1, L2, L3 and a neutral power line, N. The three power lines are connected to a number of Power Supply Units (PSUs) that are installed inside the enclosure system. In order to keep the power balance evenly distributed within the enclosure system such as a cabinet, the number of PSUs that are installed are evenly distributed within the incoming power lines (L1, L2, L3) to equalize the incoming power to the RAN node.

Existing solutions that are used to connect the RAN nodes to Low Voltage (LV) power grid is via a three-phase three-power lines system, with no redundant power line into the RAN node. Additionally, in the existing solutions, the RAN node has a certain number of PSUs connected to a certain phase of a certain power line that are typically fixed during manufacturing of the RAN node. Such an AC connection unit present inside the RAN node cannot be reconfigured after manufacturing of the RAN node since it is a static and fixed configuration. Also, output power of each PSU in the AC connection unit is balanced and fixed. Additionally, existing systems typically lose operation of at least one PSU when one or more phased inputs fails.

“AC Distribution Grid Reconfiguration using Flexible DC Link Architecture for Increasing Power Delivery Capacity during (n−1) Contingency” discloses a redundant power grid solution. The paper discloses that in case of faults in power lines on a 10 kV-rated substation, a separate power line is fed with 10 kV rating via an external Direct Current (DC) link to provide the intended 10 kV-rated power supply. Such a solution proposes an alternative topology with a hybrid DC breaker sharing common parallel paths for DC links in parallel with AC links.

U.S. Pat. No. 10,757,830 B1 discloses a system and method for managing and distributing power, wherein the system includes an electrical power input for receiving three-phase power from an external power source, a first electrical power outlet and a second electrical power outlet. The system further includes current measuring components configured to measure the current on all phases of electrical power being drawn by electrical loads connected to the first electrical power outlet and the second electrical power outlet. The system also includes a processing device to analyze measured current for all phases of electrical power being drawn by the electrical loads. Furthermore, the system includes phase balancing components configured to modify the current for each of the phases of the electrical power being drawn by the electrical loads connected to the first electrical power outlet and the second electrical power outlet such that the current for each phase is substantially balanced.

### SUMMARY

An object of the invention is to improve reliability of power supplied to an electronic device.

According to a first aspect of the invention, a method performed by a power supply distribution unit (PSDU) for an electronic device is provided. The PSDU comprises separate power supply lines (PSLs) wherein each PSL supplies a different phased input power. Each PSL is connected to one or more power supply units (PSUs) via one or more switches which connect adjacent PSLs to at least one common PSU such that an adjacent PSL can be connected or disconnected to the same one or more PSUs. The method comprises determining whether a PSL of the separate PSLs has failed or become disconnected from an input power source. The method comprises configuring, if the PSL is determined to have failed or become disconnected from the input power source, the one or more switches to separately connect at least one of the remaining PSLs of the PSLs to at least one of the one or more PSUs that was previously connected to the PSL determined to have failed or become disconnect from the input power source.

According to an embodiment, the method comprises breaking a physical connection to the PSL if the PSL is determined to have failed or become disconnected to the input power source.

According to an embodiment, the method comprises controlling the one or more switches and the one or more PSUs.

According to an embodiment, the PSDU comprises a controller and the determining comprises the controller monitoring an interface between each of the PSLs and the one or more PSUs.

According to an embodiment, the method comprises causing the configuring of the one or more switches if the PSL is determined to have failed or become disconnect from the input power source. In other words, the method comprises causing the configuring of the one or more switches if the PSL is determined to have failed or become disconnect from its power source.

According to an embodiment, the monitoring comprises monitoring one or more of input voltage, input current, and a state of the one or more switches.

According to an embodiment, the method comprises disconnecting all the PSUs from a power distribution entity (PDE) wherein the PDE provides power from the PSUs to one or more devices and/or putting each of the PSUs in a sleep mode during a time period when configuring the one or more switches and supplying input power to the PDE via a battery or an external power source and reconnecting all the PSUs to the PDE and or switch on the PSUs after the one or more switches are configured or reconfigured. According to an embodiment, the time period is a predetermined value. According to an embodiment, the time period is determined by the controller.

According to an embodiment, the PSL which is determined to have failed or become disconnected from the input power source is a first PSL which is connected to a first at least two PSUs and the remaining PSLs comprises a second PSL connected to a second at least two PSUs and a third PSL connected to a third at least two PSUs. The configuring of the one or more switches comprises: disconnecting a path from the first PSL to the first at least two PSUs; connecting the second PSL to the first at least two PSUs; disconnecting at least one of the second at least two PSUs from the second PSL; and connecting the at least one of the second at least two PSUs to the third PSL. A technical advantage of the embodiment is that the embodiment reduces power loss due to a PSL failure or a PSL which has been determined to become disconnected. The incoming power loss is typically ⅓rd of the total input power for a device drawing power from the PSDU when the PSDU comprises three PSLs, the incoming power loss is typically ¼th of the total input power for a device drawing power from a PSDU comprising four PSLs and so on.

According to an embodiment, the PSL which is determined to have failed or become disconnected from the input power source is a first PSL which is connected to a first at least two PSUs and the remaining PSLs comprises a second PSL connected to a second at least two PSUs and a third PSL connected to a third at least two PSUs. The configuring the one or more switches comprises: disconnecting a path from the first PSL to the first at least two PSUs; connecting the second PSL to at least a first one of the first at least two PSUs; connecting the third PSL to at least a second one of the first at least two PSUs. A technical advantage of the embodiment is that the embodiment reduces power loss due to a PSL failure or a PSL which has been determined to become disconnected. The incoming power loss is typically ⅓rd of the total input power for a device drawing power from the PSDU when the PSDU comprises three PSLs.

According to an embodiment, the method comprises disconnecting the PSUs and one or more switches corresponding to the PSL which has failed or the disconnected PSL.

According to an embodiment, the method comprises detecting if the PSL which has failed or the disconnected PSL has recovered.

According to an embodiment, the method comprises re-distributing the PSUs to the PSLs of the separate PSLs such that each of the PSUs receives an equal share of input from the PSLs.

According to an embodiment, the method comprises determining number of PSUs configured per PSL; and/or determining of power of the PSUs per PSL to compute the new configuration settings of the switches and new PSU positions in relation to the PSLs.

According to a second aspect of the invention, a PSDU for an electronic device is provided. The PSDU comprises separate PSLs. Each PSL supplies a different phased input power. Each PSL is connected to one or more PSUs and one or more switches which connect adjacent PSLs to at least one common PSU such that an adjacent PSL can be connected or disconnected to the same one or more PSUs. The PSDU is configured such that if each of the separate PSLs is connected to and receiving input power, each one of the separate PSLs is separately connected to one or more separate PSUs such that each PSU receives an equal share of power from the PSLs. The PSDU is configured such that if one of the separate PSLs is disconnected or fails to receive input power, the one or more switches are configured to connect the PSUs such that each of the one or more PSUs receives an equal share of input from the remaining PSLs.

According to an embodiment, the PSDU comprises a circuit breaker configured to isolate the disconnected PSL or the PSL which fails to receive input power.

According to an embodiment, the PSDU comprises a controller configured to monitor the power supplied by each of the PSLs and/or control the one or more switches in response to detecting a failure or disconnection of at least one of the PSLs. According to an embodiment, the controller is configured to monitor one or more of input voltage, input current and a state of the one or more switches.

According to an embodiment, the PSDU is configured to monitor an interface between each of the PSLs and the one or more PSUs.

According to an embodiment, the PSDU is configured to control operation of the one or more switches.

According to an embodiment, the PSDU is configured to disconnect all the PSUs from a PDE and/or set all PSUs into a sleep mode and provide power to the PDE via a battery or an external power source during a period of time that the one or more switches are configured or reconfigured. The PSDU is further configured to reconnect all the PSUs to the PDE and switch on the PSUs after the one or more switches are configured or reconfigured. According to an embodiment, the time period is a predetermined value. According to an embodiment, the time period is determined by the controller.

According to an embodiment, the PSDU is configured to disconnect all the PSUs corresponding to the PSL which is disconnected or fails to receive input power.

According to an embodiment, the PSDU is configured to detect if the disconnected PSL or the PSL which fails to receive input power has recovered.

According to an embodiment, if the disconnected PSL or the PSL which fails to receive input power has recovered, the PSDU is configured to re-distribute the PSUs to the PSLs such that each of the PSUs receives an equal share of input from the PSLs.

According to an embodiment, the PSDU is configured to determine whether a PSL of the separate PSLs has failed or become disconnected from the input power source.

According to an embodiment, the PSDU is comprised in a radio access network (RAN) node.

According to a third aspect of the invention, a PSDU for an electronic device is provided. The PSDU comprises separate PSLs. Each PSL supplies a different phased input power. Each PSL is connected to one or more PSUs and one or more switches which connect adjacent PSLs to at least one common PSU such that an adjacent PSL can be connected or disconnected to the same one or more PSUs. The PSDU comprises a processor and a memory. The memory containing instructions executable by the processor whereby the apparatus is operative to perform the method according to one or more embodiments of the first aspect.

According to a fourth aspect of the invention, a system for supplying power to an electronic device is provided. The system comprises one or more PSDUs, and a cloud orchestrator. Each of the PSDUs comprises separate PSLs wherein each PSL supplies a different phased input power. Each PSL is connected to one or more PSUs and one or more switches which connect adjacent PSLs to at least one common PSU such that an adjacent PSL can be connected or disconnected to the same one or more PSUs. The system is configured such that if each of the separate PSLs in each PSDU is connected to and receiving input power, each one of the separate PSLs is separately connected to one or more separate PSUs such that each PSU receives an equal share of power from the PSLs. The system is configured such that if one of the separate PSLs in each PSDU is disconnected or fails to receive input power, the one or more switches are configured to connect the PSUs such that each of the one or more PSUs receives an equal share of input from the remaining PSLs.

According to an embodiment, the system is configured to perform the method according to one or more embodiments of the first aspect.

According to a fifth aspect of the invention, a system for supplying power to an electronic device is provided. The system comprises one or more PSDUs, and a cloud orchestrator. Each of the PSDUs comprises separate PSLs wherein each PSL supplies a different phased input power. Each PSL is connected to one or more PSUs and one or more switches which connect adjacent PSLs to at least one common PSU such that an adjacent PSL can be connected or disconnected to the same one or more PSUs. The PSDU comprises a processor and a memory. The memory containing instructions executable by the processor whereby the system is operative to perform the method according to one or more embodiments of the first aspect.

According to a sixth aspect of the invention, a computer program comprising instructions which, when executed by at least one processor of a PSDU or a system is provided. The instructions cause the PSDU or the system to carry out the methods according to one or more of the embodiments of the first aspect.

According to a seventh aspect of the invention, a computer program product stored on a non-transitory computer readable (storage or recording) medium is provided. The computer program product comprising instructions that, when executed by a processor of a PSDU or a system, cause the PSDU or the system to perform the method according to the sixth aspect.

In the event of a PSL fault or a power feeder fault or a failure to receive input power supply at a PSL for a phase, some embodiments aim to maximize the amount of power delivered via input PSUs of the remaining PSLs or power feeder lines. The solution herein reduces the power loss due to a power line failure which is typically ⅓rd of the total input power for a device drawing power from the PSDU. In case of an incoming PSL fault, the PSDU reconfigures the PSUs corresponding to the faulty PSL based on the remaining, non-faulty, PSLs. The disclosure herein thus maximizes the output power from the remaining PSLs in a safe and reliable way.

Certain embodiments may provide one or more of the following technical advantage(s). A technical advantage of some of the embodiments presented herein is that the embodiments enable delivery of a higher power to radio loads of RAN nodes or any other device drawing power from the PSDU, without the need of adding a component such as a redundant PSL. Another technical advantage is that the provided PSDU improves the efficiency of incoming power from the power supply grid. Yet another technical advantage may be that some of the embodiments aim to equalize incoming power supply and reconfigure PSUs connection to either maintain or increase output power in case of a PSL failure or fault. Another technical advantage of some of the embodiments herein is that the solution improves reliability and availability of the RAN nodes by adjusting the input power supply to the RAN nodes. Additionally, some of the embodiments herein increase the input power supplied to the radio loads of the RAN nodes for a faulty PSL using the same PSL path.

### BRIEF DESCRIPTION OF THE DRAWINGS

The above, as well as additional objects, features and advantages of the invention, will be better understood through the following illustrative and non-limiting detailed description of embodiments of the invention, with reference to the appended drawings, in which:

FIG. 1 illustrates a prior art embodiment of a power supply distribution unit for an electronic device.

FIG. 2 illustrates a power supply distribution unit, PSDU, in accordance with an embodiment of the invention.

FIG. 3a illustrates a PSDU, in accordance with an embodiment of the invention.

FIG. 3b illustrates a PSDU, in accordance with an embodiment of the invention.

FIG. 4 illustrates a method performed by a PSDU, in accordance with an embodiment of the invention.

FIG. 5 illustrates a system, in accordance with an embodiment of the invention.

FIG. 6 illustrates an electronic device, in accordance with an embodiment of the invention.

FIG. 7 illustrates an example of an apparatus as implemented as implemented in accordance with an embodiment of the invention.

FIG. 8 illustrates a computer program product, in accordance with an embodiment of the invention.

FIG. 9 shows an example of a communication system 900, in accordance with an embodiment of the invention.

FIG. 10 shows a network node 910 in accordance with an embodiment of the invention.

All the figures are schematic, not necessarily to scale, and generally only show parts which are necessary in order to elucidate the invention, wherein other parts may be omitted or merely suggested.

### DETAILED DESCRIPTION

Some of the embodiments contemplated herein will now be described more fully with reference to the accompanying drawings. Embodiments are provided by way of example to convey the scope of the subject matter to those skilled in the art.

There currently exist many challenges in the existing solutions. Electric power grid distribution systems exist as mesh networks and consist of multiple ring formations to increase availability of power for Medium Voltage (MV) distribution networks. If faults occur, the electric power grid distribution systems operate by reconfiguring or changing the power feeder or power supply lines reconfiguration in the MV distribution network to provide fault isolation. Power supply lines/feeder reconfiguration is not performed in the LV distribution network, and all the Radio Access Network (RAN) nodes are directly connected to the LV distribution network. Thus, in the LV distribution network, if a power supply line is subjected to a fault and subsequently a power line loss occurs for one phase, many RAN nodes (for example, legacy RAN nodes such as 2G and 3G RAN nodes) may fail to maintain and deliver the power required for a particular radio load. Further, some existing solutions propose adding of additional direct current (DC) links to support an alternative topology with a hybrid DC breaker sharing common parallel paths for DC links in parallel with AC links. Adding of these new DC links adds tremendously to the complexity, cost and infrastructure of the power grid solution.

In general, each phase in the RAN node has the same number of PSUs connected to it for phase balancing purposes. Since output current of each PSU is balanced and equal, from a controller perspective, current from each phase of the three-phase power supply is also the same. In the case of single-phase power line failure, the system loses ⅓rd of its total power capacity and may severely impact the operation (for example, shutting off a radio technology in the RAN node; malfunctioning of the RAN node; corruption of the RAN node) of the RAN node.

The disclosure herein discloses a power supply distribution unit (PSDU), a method performed by the PSDU and a system comprising the PSDU for an electronic device in a network. An object of the disclosure is to maximize input power for the electronic device. Another object of the disclosure is to improve reliability and availability of the electronic device. The PSDU comprises one or more power supply lines (PSLs), one or more switches and one or more power supply units (PSUs). An advantage of the disclosure herein is avoiding adding of complex direct (DC) links and reducing costs for a power management and distribution system.

In case of a faulty condition wherein one power line with a phase at the input fails or the one power line has an incoming power supply from a faulty phase, the power system will lose ⅓rd of its output capacity when or if the power system loses one input power line. This implies that the PSUs connected to that power line with the faulty phase or the power line with a failed input is not usable and that ⅓rd of the total input power to the RAN node is lost leading to unfulfilled delivery of power to the RAN nodes.

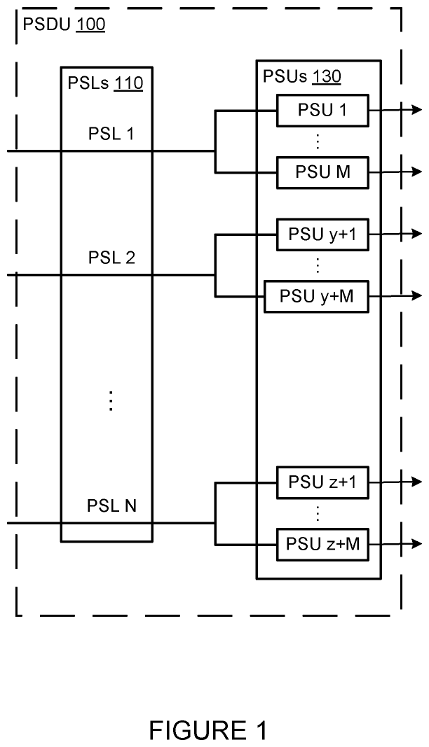

FIG. 1 illustrates an example power supply distribution unit according to the prior art wherein a PSDU 100 for an electronic device is provided. The PSDU 100 comprises one or more PSLs 110 and one or more corresponding PSUs 130 for each PSL. The PSDU 100 provides power to the electronic device via the PSLs and the PSUs corresponding to a particular PSL. Each PSL has a one-to-one or one-to-many mapping with a PSU. In an example, PSDU 110 provides power to the electronic device via PSL 1, PSL 2 and PSL 3 by delivering the power via corresponding PSUs for PSL 1, that is, PSUs 1 . . . M, PSL 2, that is, PSUs y+1 . . . y+M and PSL 3, that is, PSUs z+1 . . . z+M. In the event that there is a fault in PSL 1 or PSL 1 fails to receive any input power, the PSUs 1 . . . M will not be able to deliver the power to the electronic device. The electronic device would thus receive less power in this case than when PSL 1 was functioning properly or was not faulty. In most implementations such as, for example, U.S. Pat. No. 10,757,830 B1, the amount of power passing through each PSL of a three-phase PSL is the same. Thus, if PSL 1 is faulty, the electronic device would receive ⅓rd less power than in normal working condition for PSL 1. This is a significant loss both in terms of power to the electronic device but also reduces efficiency of power supply incoming via a power grid. Furthermore, the reduced amount of incoming power in the electronic device may cause disruptions, malfunctioning and lower availability of the electronic device. In some examples where the electronic device is a 3GPP RAN node, this fault in a PSL may cause a total shut down for some wireless communication technologies such as 2G and 3G. In some cases, the fault in a PSL may cause lower availability and lower reliability of the RAN node which often results in lower throughput of the RAN node. In other examples, where the electronic device is a non-3GPP RAN node or a non-3GPP access node, the fault in a PSL of the PSLs may cause a malfunction and/or sub-optimal reliability in the non-3GPP RAN node or non-3GPP access node.

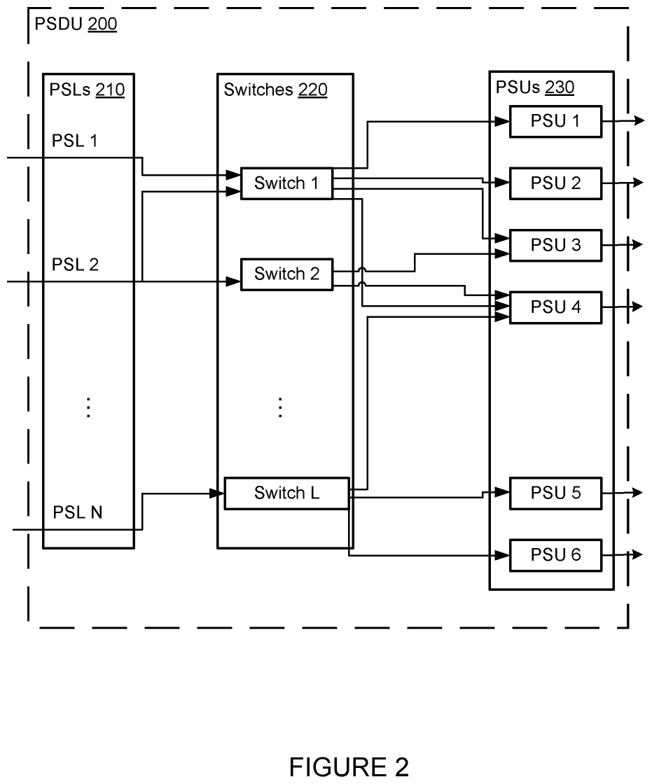

FIG. 2 illustrates a PSDU 200, in accordance with an embodiment of the disclosure. The PSDU 200 comprises separate PSLs 1 . . . N 210 wherein each PSL supplies a different phased input power. In other words, the PSDU 200 comprises a plurality of separate PSLs 210 wherein each PSL supplies a different phased input power. The PSLs 210 receive input power from a mains power supply or a power grid. Each PSL of the separate PSLs is connected to one or more PSUs, 230 (for example as depicted in FIGS. 2, 6 PSUs (1-6) may be deployed, however in other examples more or fewer PSUs may be used) and one or more switches (for example one switch per PSL) 1 . . . L 220 which connect adjacent PSLs to at least one common PSU. The PSDU 200 is configured such that an adjacent PSL of the PSLs 210 can be connected or disconnected to the same one or more PSUs of a corresponding adjacent PSL. In some examples, configuring may comprise adapting or modifying the PSDU 200. Further, the PSDU 200 is configured such that if each of the separate PSLs 210 is connected to and receiving input power, each one of the separate PSLs 210 is separately connected to one or more separate PSUs 230 such that each PSU receives an equal share of power from the separate PSLs. Suitable passive or active electronic or electrical components may be included in the paths between PSUs to the PSLs including the switches (or within the switches) to prevent current or voltage from one input being received at another input. Furthermore, the PSDU 200 is configured such that if one of the separate PSLs is disconnected or fails to receive input power, the one or more switches 220 are configured to connect the PSUs such that each of the one or more PSUs 230 receives an equal share of input from the remaining PSLs. Meaning that, if a PSL is disconnected or fails to receive input power, it refers to the PSL not receiving input power from a mains power supply or a distribution unit connected to a power grid. In other words, the switches 220 are configured to switch a PSL adjacent to a faulty or failed PSL to connect to the PSUs previously supplied by the faulty or failed PSL. In some embodiments, just like a faulty PSL, there may instead be a faulty PSU. The remaining PSUs and the PSLs may be configured to arrange themselves, such that the input power from the PSLs is equally distributed among the remaining PSUs and required power is delivered to an electronic device. In some embodiments, the PSDU 200 is configured to determine whether a PSL of the separate PSLs has failed or become disconnected from the input power source.

For example, consider that the PSDU 200 comprises three PSLs each supplying a different phased input power, PSL 1, PSL 2 and PSL 3. If PSL 1 is adjacent to PSL 2, then the PSDU 200 is configured such that either of PSL 1 or PSL 2 can be connected or disconnected to both or just one of the corresponding PSUs for PSL 1 or PSL 2. If PSUs connected to PSL 1 are PSU 1 and PSU 2, and PSUs connected to PSL 2 are PSU 3 and PSU 4, then PSU 1 and PSU 2 can be connected to PSL 2 or PSU 3 and PSU 4 can be connected to PSL 1 as well.

In an example, if total input power for a PSDU 200 comprising three PSLs is 12 kW and two PSUs are connected to each PSL, then each PSL draws 2 kW of input power. Now, if in the earlier example, PSL 1 fails to receive or draw input power or becomes faulty, the PSDU 200 dynamically re-configures PSL 2 and PSL 3 such that PSL 2 and PSL 3 can connect to the PSUs connected to PSL 1 and PSL 2, respectively such that each PSU receives an equal share of input power from the remaining PSLs, PSL 2 and PSL 3. In other words, PSL 3 is connected to its own/previous PSUs and half the PSUs previously connected to PSL 2 and PSL 2 remains connected to the other half of its previous PSUs plus the PSUs previously connected to the failed PSL 1, thereby evenly distributing the PSUs between PSL 2 and PSL 3. The total incoming input power, from the PSLs 2 and 3, may still remain 12 kW even though PSL 1 is faulty. Thus, each PSU would still receive 2 kW of input power which is the same as in the case where all three PSLs were functioning properly. In other embodiments, the number of PSUs may be greater or less but should ideally be balanced or equal for each PSL.

In an embodiment, the PSDU 200 comprises one or more switches 220 such as contactors, circuit breakers (which may be motor driven) and MOSFETs. A technical advantage of employing contactors, circuit breakers and/or MOSFETs is to dynamically and autonomously control the re-configuration of the switches to enable re-direction of power between properly functioning/non-faulty PSLs and the PSUs from the faulty PSL(s) and the PSUs. In an embodiment, the PSDU 200 comprises a circuit breaker 260 configured to isolate the disconnected PSL or the PSL which fails to receive input power.

In an embodiment, the PSDU 200 is configured to break a connection to the faulty PSL or the disconnected PSL or the PSL which fails to receive input power from a power grid or a mains power supply. The PSDU 200 may comprise a controller configured to control or toggle the switches. In an example embodiment, the PSDU 200 is configured to disconnect all the PSUs 230 from the power distribution entity, PDE, (which directs the power to one or more devices) or set the PSUs to an OFF state or sleep state 210 and supply input power to PDE via a battery or any external power source. In other words, the PSDU 200 is configured to reconfigure the PSUs corresponding to the faulty PSLs by connecting the PSUs corresponding to faulty PSLs to non-faulty PSLs. This is to avoid any large transients or power spikes during the switching/reconfiguring phases. After the reconfiguration the PSUs are set to their normal operating state or reconnected to the PDE. In other examples suitable filtering is applied between the PSU and the PDE to filter out any transients. Total incoming power at the PSDU 200 may be distributed to the remaining PSLs even if one of the PSLs is faulty since usually a significant buffer (for example, 60%-70% of the total power capacity of the PSL) of the PSL capacity is unused. In an embodiment, the PSDU 200 comprises one or more switches such as contactors, circuit breakers (which may be motor driven) and MOSFETs. A technical advantage of employing contactors, circuit breakers and/or MOSFETs is to autonomously control the re-direction of the input PSL phases. The one or more switches may be controlled by an external controller. In an embodiment, the reconfiguration of the PSUs may be computed either locally or may be computed from a cloud-based environment.

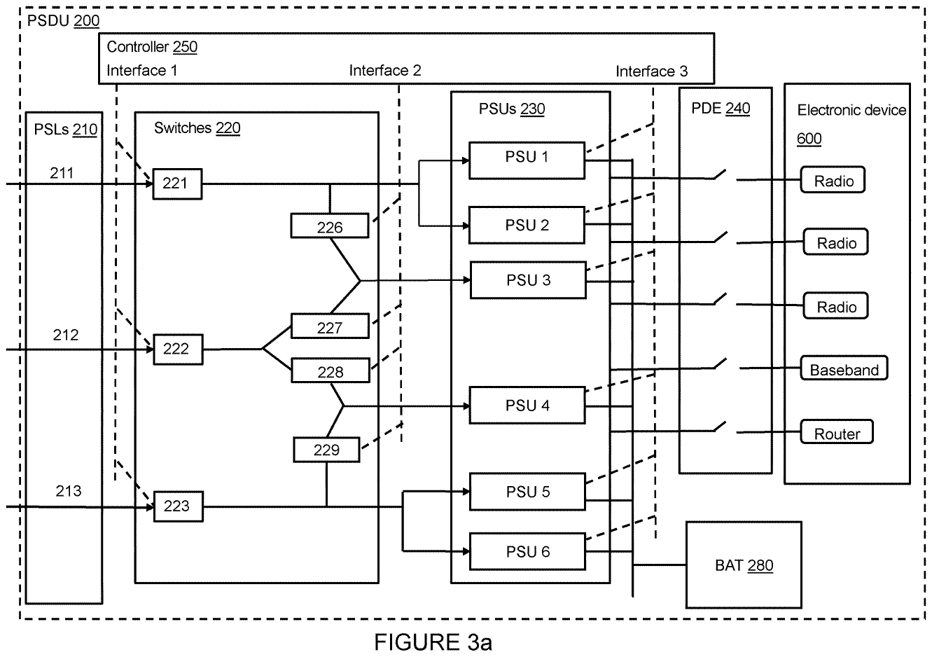

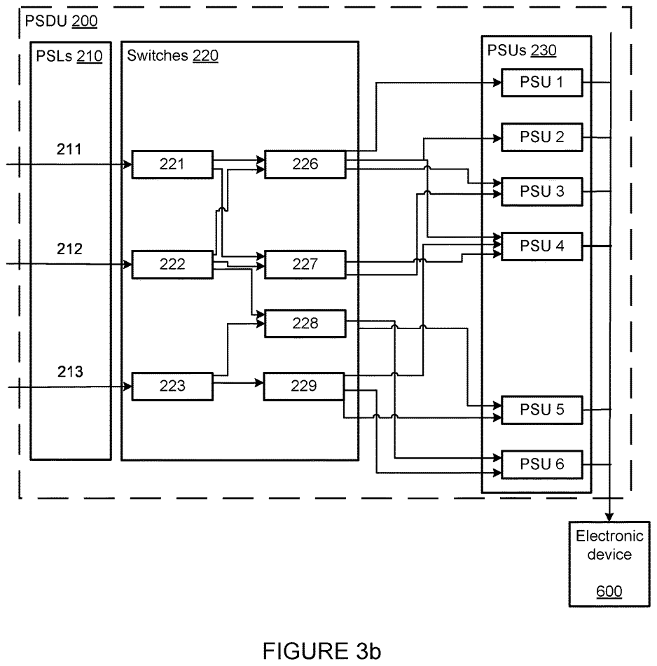

FIG. 3a illustrates a PSDU 200, in accordance with an embodiment of the invention. The PSDU 200 is configured to deliver power from a three-phase input to an electronic device 600. The electronic device may comprise one or more radio units, a baseband unit and a router. The three-phase input comprises a first phase, a second phase and a third phase and the PSLs 210 comprises a first PSL 211, a second PSL 212 and a third PSL 213. The one or more switches 220 comprises a first switch 221, a second switch 222, a third switch 223 and a switching assembly 226-229. In some embodiments, the one or more switches may be circuit breakers, relays, electrical isolators, a diode, or any passive electrical device. The first PSL 211 is connectable to the first phase, the first switch 221 and a first assembly of 2 PSUs connected in series, wherein the 2 PSUs of the first assembly are electrically connected in parallel. The second PSL 212 is connectable to the second phase, the second switch 222 and a second assembly of 2 PSUs connected in series, wherein the 2 power supply units of the second assembly are electrically connected in parallel. The third PSL 213 is connectable to the third phase, the third switch 223 and a third assembly of 2 PSUs connected in series, wherein the 2 PSUs of the third assembly are electrically connected in parallel. The switching assembly configured to allow or interrupt an electrical connection for the first assembly, the second assembly and the third assembly of PSUs. The PSDU 200 is further configured to operate the first switch, the second switch, the third switch and the switching assembly such that, upon detection of a fault in a PSL out of the first, the second or the third PSL, the remaining non-faulty PSLs each include 3 PSUs electrically connected in parallel. In some embodiments, the number of PSUs connected to each of the first, the second and the third PSL may be N PSUs each wherein N is an integer. Thus, the PSDU 200 may be further configured to operate the first switch, the second switch, the third switch and the switching assembly such that, upon detection of a fault in a PSL out of the first, the second or the third PSL, the remaining non-faulty PSLs each include N+N/2 PSUs electrically connected in parallel. In some embodiments, the number of PSUs may be greater or less than 2 but should ideally be balanced or equal corresponding to each PSL. The separate physical devices may be comprised in individual discrete components or in other examples may be comprised in a component with multiple separate functional units within the PSDU 200. In some embodiments, the PSDU 200 is configured to determine whether a PSL of the separate PSLs has failed or become disconnected from the input power source.

In an embodiment, the PSDU 200 comprises a PDE 240. The PDE 240 comprises the PSUs 230. In an embodiment, the PSDU 200 is configured to disconnect all the PSUs 230 from the PDE, 240 and/or set all PSUs into a sleep mode and provide power to the PDE 240 via a battery during a period of time that the one or more switches are configured or reconfigured and reconnect all the PSUs to the PDE and or switch on the PSUs after the one or more switches are configured or reconfigured. In an embodiment, the time period is a predetermined value. In another embodiment, the time period is determined by the controller 250. In an embodiment, the PSUs may reside outside the PDE. In an embodiment, the PSDU 200 comprises a controller 250 for enabling re-configuration of the switches in the PSDU 200 via new interfaces. In an embodiment, the controller 250 is configured to monitor the power supplied by each of the PSLs and control the one or more switches in response to detecting a failure or disconnection of at least one of the PSLs.

In an embodiment, the first switch 221 is a first circuit breaker (CB) comprising an input side and an output side, and the first switch 221 is connected to the first PSL via the input side and the first assembly of N PSUs via the output side. The second switch is a second CB comprising an input side and an output side, and the second switch is connected to the second PSL via the input side and the second assembly of N PSUs via the output side. The third switch is a third CB comprising an input side and an output side, and the third switch is connected to the third PSL via the input side and the third assembly of N PSUs via the output side.

In an embodiment, the PSDU 200 comprises a plurality of interfaces for enabling measurement of power, voltage, current and control signals in the PSDU 200. In an embodiment, the plurality of interfaces may enable re-configuration of the switches in the PSDU 200. In an embodiment, the PSDU 200 comprises an interface for monitoring input alternating current (AC) voltage (VAC) and/or AC current (IAC). In an embodiment, an interface of the interfaces is configured to remotely turn ON or turn OFF the switches, that is, controlling state of the switches 220.

In an embodiment, the PSDU 200 comprising an interface is configured to monitor VAC at a node after the switches 220 and before the PSUs 230. In an embodiment, an interface is configured to monitor state of operation of the PSUs and remotely turn ON or OFF the PSUs. In an embodiment, the PSDU 200 is configured to detect if the disconnected PSL or the PSL which fails to receive input power has recovered. If the disconnected PSL or the PSL which fails to receive input power has recovered, the PSDU is further configured to re-distribute the PSUs to the PSLs. In an embodiment, the PSDU 200 is comprised in an electronic device. In another embodiment, the PSDU 200 is comprised in a RAN node. In an embodiment, PSDU comprises the controller 250. The controller is configured to monitor input voltage and/or input current and/or a state of the one or more switches 220. In an embodiment, the controller 250 is configured to monitor an interface between each of the PSLs and the one or more PSUs. In an embodiment, the controller is configured to monitor the power supplied by each of the PSLs and control the one or more switches in response to detecting a failure or disconnection of at least one of the PSLs. In an embodiment, the controller is configured to control operation of the one or more switches 220.

In an embodiment, the switching assembly comprises a fourth switch 226, a fifth switch 227, a sixth switch 228 and a seventh switch 229, each comprising a first side, a second side and a third side. In an embodiment, the first assembly of N PSUs is connected to the output side of the first switch 221 and the first side of the fourth switch 226 via a first node placed before the first assembly. N/2 PSUs of the second assembly of N PSUs are connected to the second side of the fourth switch 226 and the second side of the fifth switch 227 via a second node placed before the second assembly while the remaining N/2 PSUs of the second assembly are connected to the second side of the sixth switch 228 and the second side of the seventh switch 229 via a third node placed before the second assembly. The third assembly of N PSUs is connected to the output side of the third switch 223 and the first side of the seventh switch 229 via a fourth node placed before the third assembly. The output side of the second switch 222, the first side the fifth switch 227, the first side of the sixth switch 228 are connected via a fifth node placed before the second assembly. The first, second and third assembly of N PSUs are connected via a sixth node placed after the first, second and third assembly, wherein the sixth node is configured to deliver power to the electronic device 600. The arrangements of the embodiments herein enable monitoring of input voltage and/or input current at the switches and the PSUs, and enable swift switching to non-faulty PSLs while ensuring minimum or no cross conduction in the PSDU 200. In an embodiment, in initial state, the first switch, the second switch and the third switch are switched on, the fourth switch is switched off, the fifth switch and the sixth switch are turned on, and the seventh switch is turned off.

In an embodiment, the controller 250 is connected to the input side of each of the first switch, the second switch and the third switch. In an embodiment, the controller is connected to the third side of each of the fourth switch, the fifth switch, the sixth switch and seventh switch. Further, the controller 250 is connected to the first node, the second node, the third node, the fourth node, the fifth node. In an embodiment, the controller is configured to monitor input voltage and/or input current for each PSU from the first, the second and the third assembly and each PSL from the PSLs. The controller is further configured to monitor state of the first, second, third, fourth, fifth, sixth, and seventh switch. Furthermore, the controller is configured to control operation of the first, second, third, fourth, fifth, sixth, and seventh switch. In an embodiment, the controller is configured to detect if any of the first phase, the second phase or the third phase is faulty. In an embodiment, the controller is configured to toggle the fourth switch, the fifth switch, the sixth switch and the seventh switch based on the detection of a faulty phase. In an embodiment, the controller is configured to disconnect the N PSUs and a switch corresponding to the PSL connected to a faulty phase. In an embodiment, the controller is configured to distribute the N PSUs corresponding to the first, second and third assembly evenly such that equal power is delivered to the electronic device 600 via PSLs connected to phases other than the faulty phase.

In an embodiment, the PSDU 200 comprises an interface, interface 1, for monitoring input alternating current (AC) voltage (VAC) and AC current (IAC). The interface 1 additionally is configured to toggle (turn ON/OFF) the switches 221-223. In an embodiment, an interface, interface 2, is configured to monitor VAC and IAC at a node after the switches 220 and before the PSUs 230. The interface 2 is further configured to turn ON or OFF the switches 226-229. In an embodiment, an interface, interface 3 is configured to monitor state of operation of the PSUs including monitoring IAC and VAC for the PSUs and remotely turn ON or OFF the PSUs. In an embodiment, the interface 3 is configured to detect if the disconnected PSL or the PSL which fails to receive input power has recovered.

FIG. 3b illustrates a PSDU 200, in accordance with an embodiment of the invention. The PSDU 200 comprises PSLs 210. The PSLs 210 comprise a first PSL 211, a second PSL 212 and a third PSL 213. Each of the three PSLs 211, 212 and 213 are identical and derive power from a phase of a three-phase input power source. The PSDU 200 comprises switches 220 comprising a switching assembly 220. The switching assembly comprises switches 221, 222, 223, 226, 227, 228 and 229. The switches 221-223 are configured to act as circuit breakers, CBs such that there is no cross-conduction between the PSLs if either of the PSLs 210 is faulty or not receiving input power. The switches 221-223 are further configured to advantageously provide isolation to one or more PSLs 210 which may be faulty. The switches 221-223 comprise a single input line and more than one output lines such that the switches 221-223 are connected to the switches 226-229 in a re-configurable and adaptive manner to route incoming power from non-faulty PSLs to the switches 226-229. The switches 226-229 are configured to supply the incoming power to the PSUs 1-6 of the PSUs 230 from the PSLs 211, 212 and 213. The switches 226-229 are configured in a re-configurable and adaptive manner such that the switches 226-229 may route incoming power from non-faulty PSLs to the PSUs 230 while maximizing input power to the PSUs. The PSUs 230 comprises a set of three equal-numbered PSUs such that each set of PSUs comprises 2 PSUs. In other embodiments, the number of PSUs corresponding to each PSL could be lesser or greater than 2 and the number of PSUs corresponding to each PSL is an integer. The PSUs 230 are configured to supply power to an electronic device 600. In an example, the electronic device 600 may be a RAN node. In an embodiment, the switches 220 comprises a switching assembly such that the switching assembly provides for isolation of faulty PSLs, re-configuration of incoming power from PSLs and flexibility to maximize the amount of incoming power to the PSUs 230. The switching assembly may be realized in several ways, not limited to the examples and embodiments herein.

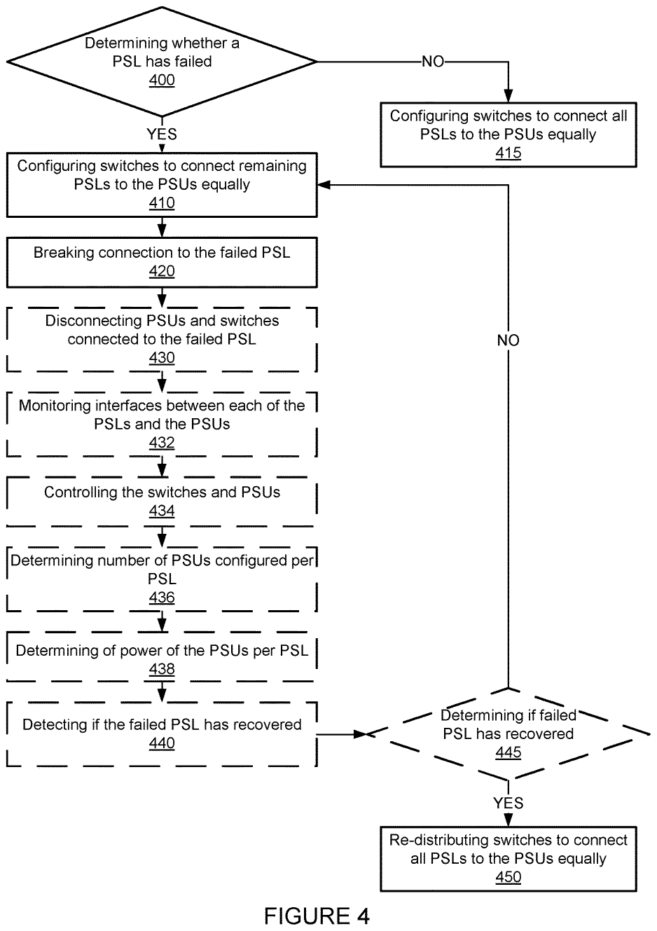

FIG. 4 illustrates a method performed by a PSDU 200, in accordance with an embodiment of the invention. A method performed by a PSDU is provided. The PSDU comprising separate power supply lines, PSLs, 210 wherein each PSL supplies a different phased input power and each PSL is connected to one or more power supply units, PSUs 230 via one or more switches which connect adjacent PSLs of the PSLs to at least one common PSU such that an adjacent PSL can be connected or disconnected to the same one or more PSUs. In the described method, the ideal situation is that an equal number of PSUs are connected to each PSL such that the system is balanced. Hence the embodiments described refer to connecting all PSUs to PSUs “equally”. In some real-world scenarios, this “balance” or “equality” should be interpreted as substantially equal. For example, if an uneven number of PSUs are available then one PSL may be one more or one less PSU than another PSL but the intention to adapt the remaining number of PSUs to be substantially equal between each PSL remains.

The method comprises, step 400, determining whether a PSL of the separate PSLs has failed or become disconnected from an input power source. The method comprises, step 410, configuring, if the PSL is determined to have failed or become disconnected from the input power source, the one or more switches to separately connect at least one of the remaining PSLs of the PSLs to at least one of the one or more PSUs that was previously connected to the PSL determined to have failed or become disconnect from its power source. In other words, the method comprises, step 410, configuring, if the PSL is determined to have failed or become disconnected from the input power source, the one or more switches to separately connect at least one of the remaining PSLs of the PSLs to at least one of the one or more PSUs that was previously connected to the PSL determined to have failed or become disconnect from the input power source it was previously connected to. In an embodiment, the method further comprises configuring the one or more switches to connect the PSUs such that each of the one or more PSUs receives an equal share of input from the remaining PSLs, if one of the separate PSLs is disconnected or fails to receive input power. The method comprises, step 415, if it is determined that a PSL has not failed or become disconnected, configuring each one of the separate PSLs to separately connect to one or more separate PSUs such that each PSU receives an equal share of power from the PSLs, if each of the separate PSLs is connected to and receiving input power. The method comprises, step 420, breaking a connection to the disconnected PSL or the PSL which fails to receive input power. In some examples the step 420 may precede the step 410. The method optionally comprises, step 430, disconnecting the PSUs 230 and one or more switches 220 corresponding to the PSL which has failed or the disconnected PSL. In some examples the step 430 may precede step 420 and/or step 410. The method optionally comprises, step 440, detecting if the PSL which has failed or the disconnected PSL has recovered. The method optionally comprises, step 445, determining if the PSL which has failed or the disconnected PSL has recovered. The method optionally comprises, step 450, if the faulty PSL has recovered, re-distributing the PSUs 230 to the PSLs 210 such that each of the PSUs receives an equal share of input from the PSLs. The method optionally comprises, going back to step 410, if the faulty PSL has not yet recovered.

In an embodiment, the method comprising waiting for a few seconds (for example, 5 seconds) to determine a disconnected PSL or a PSL which fails to receive input power 400 or a failed PSL has recovered 445. If the disconnected PSL or a PSL which fails to receive input power is determine to have failed or if the determination of a failed PSL being recovered is false (that is, the failed PSL has not yet recovered), in an embodiment, the method comprises, a step 452, disconnecting all the PSUs 230 from the PDE 240 wherein the PDE provides power from the PSUs to one or more devices and/or, a step 454, putting each of the PSUs in a sleep mode during a time period when or if configuring the one or more switches and supplying input power to the PDE via a battery or an external power source and/or, a step 456, reconnecting all the PSUs to the PDE and or switch on the PSUs after the one or more switches are configured or reconfigured. In an embodiment, the time period is a predetermined value. In an embodiment, the time period is determined by the controller 250.

In an example embodiment, the PSL which is determined to have failed or become disconnected from the input power source is a first PSL 211 which is connected to a first at least two PSUs (PSU 1 and PSU 2) and the remaining PSLs comprises a second PSL 212 connected to a second at least two PSUs (PSU 3 and PSU 4) and a third PSL 213 connected to a third at least two PSUs (PSU 5 and PSU 6). The method comprises configuring of the one or more switches comprises, a step 470, disconnecting a path from the first PSL 211 to the first at least two PSUs (PSU 1 and PSU 2). The method further comprises, a step 472, connecting the second PSL 212 to the first at least two PSUs (PSU 1 and PSU 2). Further, the method comprises, a step 474, disconnecting at least one of the second at least two PSUs (PSU 4) from the second PSL 212. Furthermore, the method comprises, a step 476, connecting the at least one of the second at least two PSUs (PSU 4) to the third PSL 213. In an embodiment, the number of PSUs connected to each of the PSLs 211, 212 and 213 may be lesser or greater than 2 PSUs.

In another example embodiment, the PSL which is determined to have failed or become disconnect from the input power source is a first PSL 212 which is connected to a first at least two PSUs (PSU 3 and PSU 4) and the remaining PSLs comprises a second PSL 211 connected to a second at least two PSUs (PSU 1 and PSU 2) and a third PSL 213 connected to a third at least two PSUs (PSU 5 and PSU 6). The configuring of the one or more switches comprises, a step 480, disconnecting a path from the first PSL 212 to the first at least two PSUs (PSU 3 and PSU 4). The method further comprises, a step 482, connecting the second PSL 211 to at least a first one of the first at least two PSUs (PSU 3) and, a step 484, connecting the third PSL 213 to at least a second one of the first at least two PSUs (PSU 4). The number of PSUs may be distributed such that each of the remaining PSLs comprise an equal number of PSUs if suppose a PSL is determined to have failed or become disconnected from the input power source.

In an embodiment, wherein the PSDU 200 comprises a controller 250, the determining, step 400, comprises the controller optionally monitoring, step 432, an interface between each of the PSLs and the one or more PSUs. In an embodiment, the controller 250 performs a method causing the configuring of the one or more switches if the PSL is determined to have failed or become disconnect from the input power source. In other words, the controller 250 performs a method causing the configuring of the one or more switches if the PSL is determined to have failed or become disconnect from its power source. In an embodiment, the method optionally comprises, step 434, controlling the switches and/or the PSUs via the controller 250. In an embodiment, the method comprises monitoring input voltage and/or input current and/or a state of the one or more switches. In an embodiment, the method comprises disconnecting all the PSUs from the input PSLs and supplying input power to the PSUs via a battery 280. In an embodiment, the method optionally comprises, step 436, determining number of PSUs configured per PSL or per phase. In an embodiment, the method optionally comprises, step 438, determining of power of the PSUs per PSL or per phase to compute the new configuration settings of the switches and new PSU positions in relation to the PSLs or the phases. All the steps presented herein may be performed by a PSDU 200 without a controller as well. The method steps and the optional method steps described herein may be advantageously combined in any permutation.

In an embodiment, the invention herein provides a method for detecting if an incoming PSL phase is lost or fails, such that the PSDU reconfigures by connecting the PSUs to the remaining, “working” PSL phases to deliver maximum power to radio loads at a RAN node. In an embodiment, the method comprises monitoring and reconfiguring connected to the interfaces 1, 2 and 3 of the controller 250. A technical advantage of the method presented herein is that it avoids cross conduction between incoming PSL phases by disconnecting the faulty PSL phase before reconfiguring the components (for example, switches 220 and PSUs 230) of the PSDU 200. In an embodiment, the controller 250 continuously monitors one or more of the input voltage, input current, and power status of each component connected to the interfaces 1, 2 and 3 of the controller 250.

In an embodiment, the method comprises configuring the switches 220 comprising a switching assembly 226-229 to provide isolation of faulty PSLs, re-configuration of incoming power from PSLs and flexibility to maximize the amount of incoming power to the PSUs 230. In an example, the method comprises turning OFF the first switch to isolate and avoid cross conduction of the first PSL or the input from the first PSL or the first phase if the first PSL is faulty. Advantageously, the method enables avoiding a short circuit between the first PSL and the second PSL due to any error in the PSDU. The same may apply for any other combination of the PSLs in the PSDU 200. In an embodiment, the method comprises turning the PSUs corresponding to the faulty PSL to OFF state to avoid large transients during the re-configuration and re-connection with the remaining PSLs or the remaining phases. In an embodiment, the method comprises turning OFF the third switch, waiting for a few seconds (for example, 3 seconds) and turning ON the seventh switch to move N/2 of the PSUs corresponding to the second PSL to the third PSL or the third phase. The method further comprises waiting for a few seconds (for example, 3 seconds) and turning ON the fourth switch to move the PSUs corresponding to the first PSL and the remaining N/2 PSUs corresponding to the second PSL to the second PSL phase 2. If N is even, then there is an equal split of PSUs corresponding to the faulty PSL. If N is odd, there is an equal split of PSUs corresponding to the faulty PSL, wherein one of the parts consists of N/2+0.5 PSUs and the other remaining part consists of N/2−0.5 PSUs. In some embodiments, if N is odd, then (N−1)/2 PSUs are divided equally into receiving power from the incoming non-faulty PSLs. In an embodiment, the method comprises reading or monitoring status of each of the PSUs and controlling the PSUs.

In an embodiment, the method comprises turning ON a PSU and then monitoring or reading the PSU input voltage and/or the input current to make sure the PSUs are evenly connected to the first PSL, the second PSL and the third PSL. The control of the first, the second and the third switch and the fourth, fifth, sixth and seventh switch are not performed simultaneously. This method provides a technical advantage to avoid cross conductions and transients on re-configuration of the switches 220 and the PSUs 230. In an embodiment, the method comprises monitoring the state of the switches 220 and the PSUs 230 as long as the first PSL is faulty, or the first phase is lost. When or if the first phase or the first PSL is back/recovered, then method returns to functioning as described in step 415. The method can be suitably adapted to when or if there is a failure at the second PSL or the third PSL or any other PSL of the PSDU 200.

In the example presented earlier, the method comprises checking input power at each of the first PSL, the second PSL and the third PSL. Upon recovery of the first PSL, the method comprising reversing the steps performed in the example presented before regarding failure of the first PSL. The method comprises turning OFF each of the PSUs and waiting for a few seconds (for example, 3 seconds). Further, the method comprises turning OFF the first switch and waiting for a few seconds (for example, 3 seconds). The method further comprises turning OFF the seventh switch and waiting for a few seconds (for example, 3 seconds). Furthermore, the reversal method comprises turning ON the third switch and waiting for a few seconds (for example, 3 seconds). The method comprises turning ON the PSUs and waiting for a few seconds (for example, 3 seconds). The method comprises turning ON the first switch and waiting for a few seconds (for example, 3 seconds). In an embodiment, the method comprises reading or monitoring input AC voltage or current and status of the PSUs to make sure PSUs are evenly connected to the three PSLs. A similar method and a process of reversal of the method may be applicable if the second PSL or the third PSL are determined to be faulty and then subsequently recover.

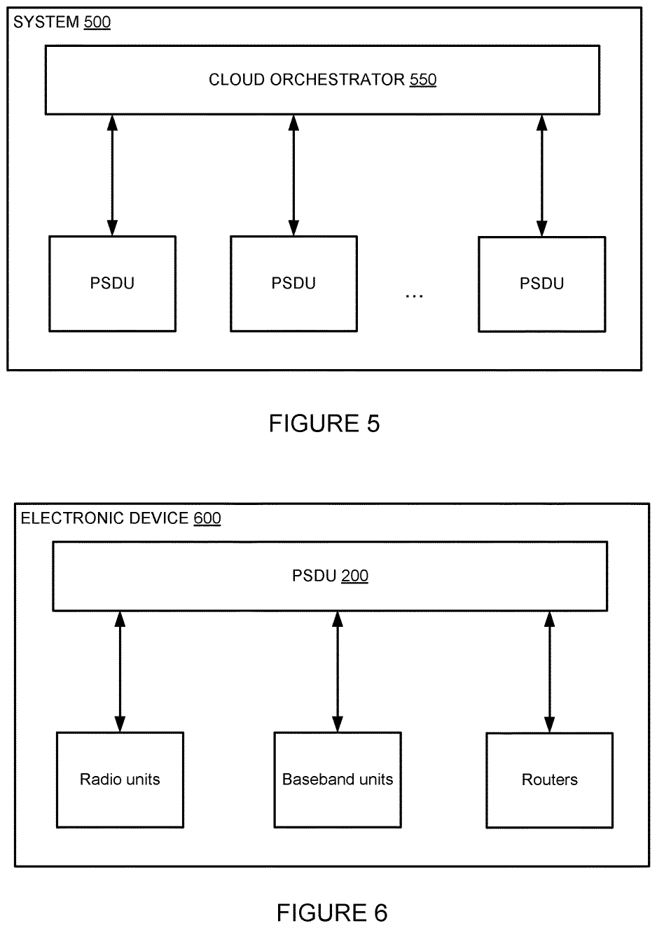

FIG. 5 illustrates a system 500, in accordance with an embodiment of the invention. The system 500 comprises one or more power supply distribution units, PSDUs, and a cloud orchestrator, 550. Each of the PSDUs comprises a separate power supply lines, PSLs, wherein each PSL supplies a different phased input power, each PSL is connected to one or more power supply units, PSUs, and one or more switches which connect adjacent PSLs to at least one common PSU such that an adjacent PSL can be connected or disconnected to the same one or more PSUs. The system is configured such that if each of the separate PSLs in each PSDU is connected to and receiving input power, each one of the separate PSLs is separately connected to one or more separate PSUs such that each PSU receives an equal share of power from the PSLs. Further, the system is further configured such that if one of the separate PSLs in each PSDU is disconnected or fails to receive input power, the one or more switches are configured to connect the PSUs such that each of the one or more PSUs receives an equal share of input from the remaining PSLs. In an embodiment, the system is configured to perform operations according to one or more of the methods of the PSDU 200. The cloud orchestrator may be configured to perform the operations as defined in the text relating to the method of FIG. 4. In an embodiment, the cloud orchestrator 550 is configured to monitor one or more of input voltage, input current and states of the switches. In an embodiment, the cloud orchestrator is configured to control the switches 220. The cloud orchestrator may control the functioning of one or more PSDUs delivering power to one or more electronic devices. The cloud orchestrator is configured to monitor information from multiple electronic devices comprising the one or more PSDUs. In an embodiment, a local controller for an electronic device may detect phase loss at a PSL, and then report the same to the cloud orchestrator.

FIG. 6 illustrates an electronic device 600, in accordance with an embodiment of the invention. The electronic device 600 comprises a RAN node. The RAN node comprises one or more radio units, one or more baseband units and one or more routers. The PSDU is configured to deliver power to the electronic device. The RAN node may comprise the PSDU. In some embodiments, the RAN node receives power from the PSDU externally.

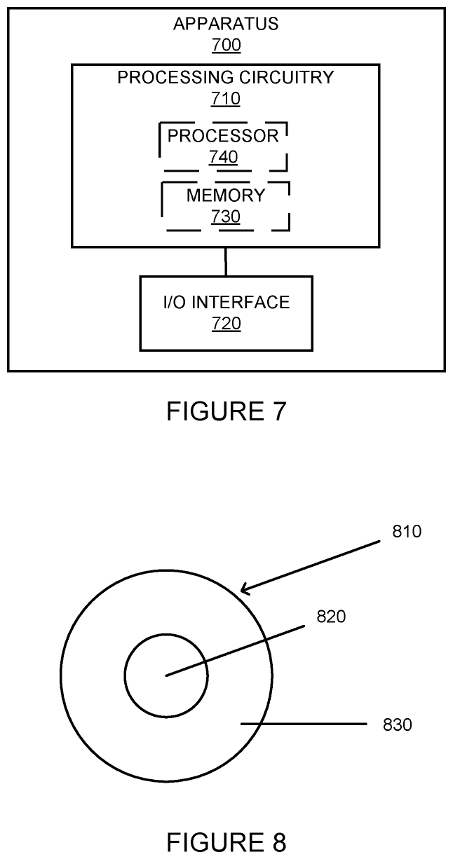

FIG. 7 illustrates an example of an apparatus 700 as implemented in accordance with an embodiment of the invention. The apparatus 700 may be either a PSDU 200 or a system 500. A processing circuitry 710 is adapted/configured/operable to cause the controller to perform a set of operations, or for example, steps, 400, 410, 415, 420, 430, 432, 434, 436, 440, 450 as disclosed above, e.g., by executing instructions stored in memory 730. The processing circuitry 710 may comprise one or more of a microprocessor, a controller, a microcontroller, a central a processing unit, a digital signal processor, an application-specific integrated circuit, a field programmable gate array, or any other suitable computing device, resource, or combination of hardware, software and/or encoded logic operable to provide, either alone or in conjunction with other components of the apparatus 700, such as the memory 730, in order to provide relevant functionality. The processing circuitry 710 in this regard may implement certain functional means, units, or modules. Memory 730 may include one or more non-volatile storage medium and/or one or more volatile storage medium or a cloud-based storage medium. In embodiments where processing circuitry 710 includes a programmable processor 740, a computer program product 810 may be provided in the PSDU 200 or the system 500. Such computer program product is described in relation to FIG. 8. The memory 710 may store any suitable instructions, data, or information, including software, an application including one or more of logic, rules, code, tables, and/or other instructions/computer program code capable of being executed by the processing circuitry 710 and utilized by the apparatus 700. The memory 730 may further be used to store any calculations made by the processing circuitry 710 and/or any data received via the I/O interface circuitry 720, such as input from the apparatus 700. In some embodiments, the processing circuitry 710 and memory 730 are integrated.

FIG. 8 illustrates one example of a computer program product in accordance with an embodiment of the invention. Computer program product 810 includes a computer readable storage medium 830 storing a computer program 820 comprising computer readable instructions. Computer readable medium 830 of the apparatus 700, may be a non-transitory computer readable medium, such as, magnetic media (e.g., a hard disk), optical media, memory devices (e.g., random access memory, flash memory), and the like. In some embodiments, the computer readable instructions of computer program 820 are configured such that when executed by processing circuitry 710, the computer readable instructions cause the apparatus 700 to perform steps described herein (e.g., 400, 410, 415, 420, 430, 432, 434, 436, 440, 450). In other embodiments, the apparatus 700 may be configured/operable to perform steps described herein without the need for code. That is, for example, processing circuitry 710 may consist merely of one or more ASICs. Hence, the features of the embodiments described herein may be implemented in hardware and/or software.

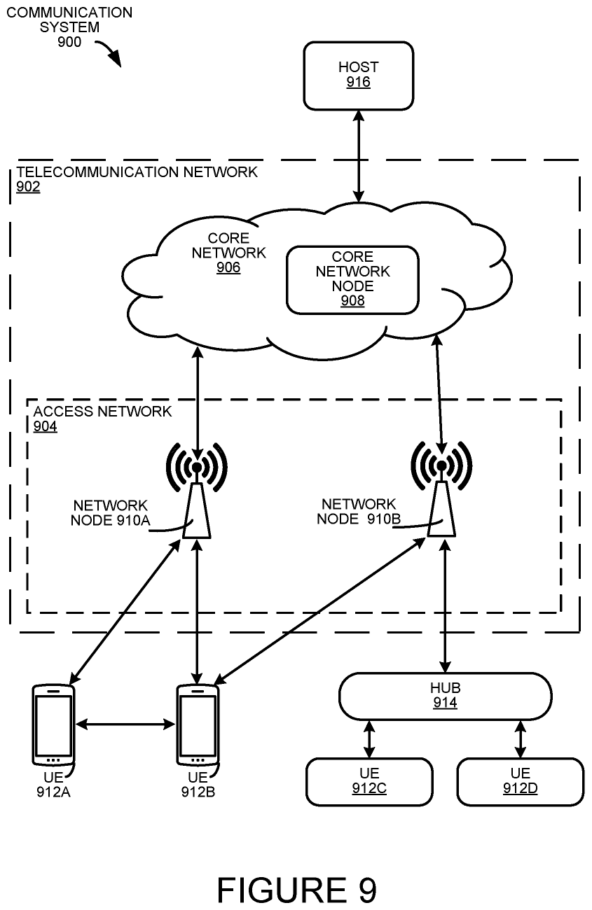

FIG. 9 shows an example of a communication system 900 in accordance with some embodiments. In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3rd Generation Partnership Project (3GPP) access nodes or non-3GPP access points. The electronic device 600 and/or the apparatus 700 may comprise a network node 910. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 902 includes one or more Open-RAN (ORAN) network nodes. An ORAN network node is a node in the telecommunication network 902 that supports an ORAN specification (e.g., a specification published by the O-RAN Alliance, or any similar organization) and may operate alone or together with other nodes to implement one or more functionalities of any node in the telecommunication network 902, including one or more network nodes 910 and/or core network nodes 908. Examples of 3GPP RAN nodes are a 2G RAN node or a base transceiver substation, a 3G RAN node or a nodeB, a 4G RAN node or a nodeB, a 5G RAN node or a gNodeB, a 6G RAN node or any other RAN node in future communications technologies. Examples of non-3GPP RAN nodes or non-3GPP access node are an IoT access node or a vehicular communication access node or any other RAN or access node in other communications technologies.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

Preferably, the communication system 900 comprises an electronic device 600. Preferably, the communication system 900 comprises a system 500. Preferably, the communication system 900 comprises an apparatus 700. Examples of an electronic device 600 in the communication system 900 are, but not limited to, a 3GPP network node, a non-3GPP network node, an IoT network node, a cloud-native network node, a constrained network node, a vehicular communication network node or any other node in any of the aforementioned network types. In an example, the electronic device 600 specified herein may either be an IoT device, a constrained device, a cloud-native device, a telecommunications device, or a network device such as a 3GPP Radio Access Network (RAN) node, a core network node, an external 3rd party node or any other non-3GPP access node. In an embodiment, the network 600 may comprise or be a RAN. In an embodiment, the electronic device 600 may comprise or be a RAN node.

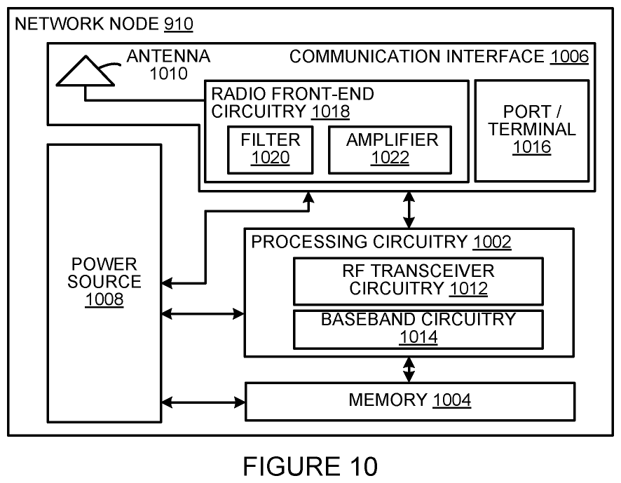

FIG. 10 shows a network node 910 in accordance with an embodiment of the invention. The electronic device 600 or the apparatus 700 may comprise the network node 910. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 910 includes a processing circuitry 1002, a memory 1004, a communication interface 1006, and a power source 1008. The network node 910 may be composed of multiple physically separate components (e.g., a NodeB component and a RNC component, or a BTS component and a BSC component, etc.), which may each have their own respective components. In certain scenarios in which the network node 910 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 910 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 910 may also include multiple sets of the various illustrated components for different wireless technologies integrated into network node 910, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 910.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 910 components, such as the memory 1004, to provide network node 910 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 910. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 910 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 910 and connectable to the network node 910 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 910 in a form suitable for the respective components (e.g., at a voltage and current level needed for each respective component). The power source 1008 may further comprise, or be coupled to, power management circuitry to supply the components of the network node 910 with power for performing the functionality described herein. For example, the network node 910 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail. The power source 1008 for the network node 910 or the apparatus 700 may be the PSDU 200 or the system 500.

Embodiments of the network node 910 may include additional components beyond those shown in FIG. 10 for providing certain aspects of the network node's functionality, including any of the functionality described herein and/or any functionality necessary to support the subject matter described herein. For example, the network node 910 may include user interface equipment to allow input of information into the network node 910 and to allow output of information from the network node 910. This may allow a user to perform diagnostic, maintenance, repair, and other administrative functions for the network node 910.

The computer program code mentioned above may also be provided, for instance in the form of a data carrier carrying computer program code for performing the embodiments herein when being loaded into the hardware. One such carrier may be in the form of a CD ROM disc. It is however feasible with other data carriers such as a memory stick. The computer program code may furthermore be provided as pure program code on a PSDU 200 or a system 500, and downloaded to the hardware at production, and/or during software updates.

The person skilled in the art will appreciate that the blocks in the circuit diagram of the PSDU 200 may refer to a combination of analog and digital circuits, and/or one or more controllers, configured with software and/or firmware, e.g. stored in one or more local storage units, that when executed by the PSDU 200 or the system 500 perform the steps as described above. One or more of the PSDU 200 or the system 500, as well as any other combination of analog and digital circuits, may be included in a single application-specific integrated circuitry (ASIC), or several controllers and various digital hardware may be distributed among several separate components, whether individually packaged or assembled into a system-on-a-chip (SoC). The one or more PSDU 200 or the system 500 may be any one of, or a combination of a central processing unit (CPU), graphical processing unit (GPU), programmable logic array (PAL) or any other similar type of circuit or logical arrangement. The teachings of these embodiments presented herein may improve the availability and reliability of the electronic device and thereby provide benefits such as higher throughput and/or lower latency.

1-35. (canceled)

36. A method performed by a power supply distribution unit (PSDU) for an electronic device, wherein the PSDU comprises a plurality of power supply lines (PSLs), wherein each PSL supplies a different phased input power, and each PSL is connected to one or more power supply units (PSUs) via one or more switches which connect adjacent PSLs to at least one common PSU such that an adjacent PSL can be connected or disconnected to the same one or more PSUs, and the method comprises:
determining whether a PSL of the plurality of PSLs has failed or become disconnected from an input power source; and
as a result of determining that the PSL has failed or become disconnected from the input power source, configuring the one or more switches to separately connect at least one of the other PSLs to at least one of the one or more PSUs that was previously connected to the PSL determined to have failed or become disconnected from the input power source.

37. A power supply distribution unit (PSDU) for an electronic device, the PSDU comprising:
a plurality of power supply lines (PSLs), wherein
each PSL supplies a different phased input power,
each PSL is connected to one or more power supply units (PSUs) and one or more switches which connect adjacent PSLs to at least one common PSU such that an adjacent PSL can be connected or disconnected to the same one or more PSUs, and
the PSDU is configured such that:
if each of the PSLs is connected to and receiving input power, each one of the PSLs is separately connected to one or more separate PSUs such that each PSU receives an equal share of power from the PSLs; and
if one of the PSLs is disconnected or fails to receive input power, the one or more switches are configured to connect the PSUs such that each of the one or more PSUs receives an equal share of input from the remaining PSLs.

38. The PSDU of claim 37, wherein
the PDSU further comprises a circuit breaker configured to isolate the disconnected PSL or the PSL which fails to receive input power.

39. The PSDU of claim 37, wherein
the PDSU further comprises a controller configured to monitor the power supplied by each of the PSLs and/or control the one or more switches in response to detecting a failure or disconnection of at least one of the PSLs.

40. The PSDU of claim 39, wherein
the controller is configured to monitor input voltage, input current, and/or a state of the one or more switches.

41. The PSDU of claim 39, wherein
the PDSU is further configured to monitor an interface between each of the PSLs and the one or more PSUs.

42. The PSDU of claim 39, wherein
the PDSU is further configured to control operation of the one or more switches.

43. The PSDU of claim 37, wherein
the PDSU is further configured to disconnect all the PSUs from a power distribution entity, PDE, and/or set all PSUs into a sleep mode and provide power to the PDE via a battery or an external power source during a period of time that the one or more switches are configured or reconfigured and reconnect all the PSUs to the PDE and switch on the PSUs after the one or more switches are configured or reconfigured.

44. The PSDU of claim 37, wherein
the PDSU is further configured to disconnect all the PSUs corresponding to the PSL which is disconnected or fails to receive input power.

45. The PSDU of claim 37, wherein
the PDSU is further configured to detect if the disconnected PSL or the PSL which fails to receive input power has recovered.

46. The PSDU of claim 37, wherein
the PDSU is further configured to determine whether a PSL of the plurality of PSLs has failed or become disconnected from the input power source.

47. A radio access network node comprising the PDSU of claim 37.

48. A power supply distribution unit (PSDU) for an electronic device, the PSDU comprising:
a plurality of power supply lines (PSLs), wherein each PSL supplies a different phased input power, and each PSL is connected to i) one or more power supply units (PSUs) and ii) one or more switches which connect adjacent PSLs to at least one common PSU such that an adjacent PSL can be connected or disconnected to the same one or more PSUs;
memory; and
processing circuitry, wherein
the memory stores instructions for configuring the PSDU to perform the method of claim 37.

49. A system for supplying power to an electronic device, the system comprising:
a power supply distribution unit (PSDU); and
a cloud orchestrator, wherein
the PSDU comprises a plurality of power supply lines (PSLs),
each PSL supplies a different phased input power,
each PSL is connected to one or more power supply units (PSUs) and one or more switches which connect adjacent PSLs to at least one common PSU such that an adjacent PSL can be connected or disconnected to the same one or more PSUs, and
the system is configured such that:
if each of the PSLs is connected to and receiving input power, each one of the PSLs is separately connected to one or more separate PSUs such that each PSU receives an equal share of power from the PSLs; and
if one of the PSLs is disconnected or fails to receive input power, the one or more switches are configured to connect the PSUs such that each of the one or more PSUs receives an equal share of input from the remaining PSLs.
